(19) United States
(12) Patent Application Publication
(10) Pub. No.: US 2026/0129076 A1
(43) Pub. Date: May 7, 2026

(54) SYSTEMS AND METHODS FOR ADVERSARIAL TEXT PURIFICATION VIA LARGE LANGUAGE MODELS

(71) Applicants: Raha Moraffah, Chandler, AZ (US); Shubh Khandelwal, Scottsdale, AZ (US); Amrita Bhattacharjee, Tempe, AZ (US); Huan Liu, Tempe, AZ (US)

(72) Inventors: Raha Moraffah, Chandler, AZ (US); Shubh Khandelwal, Scottsdale, AZ (US); Amrita Bhattacharjee, Tempe, AZ (US); Huan Liu, Tempe, AZ (US)

(73) Assignee: Arizona Board of Regents on Behalf of Arizona State University, Tempe, AZ (US)

(21) Appl. No.: 19/340,409

(22) Filed: Sep. 25, 2025

Related U.S. Application Data
(60) Provisional application No. 63/699,051, filed on Sep. 25, 2024.

(51) Int. Cl. H04L 9/40; G06F 16/3332

(52) U.S. Cl. CPC H04L 63/1466; G06F 16/3332

(57) ABSTRACT

Examples inventive concepts of using adversarial text purification for adversarial attack defense are provided that in general take adversarial input texts to text classifiers and purify them into samples that are synonymous with the inputs but are benign (i.e., correctly classified by the classifiers). This harnesses the generative capabilities of LLMs to purify adversarial text without the need to explicitly characterize the discrete noise perturbations. Prompt engineering is implemented to exploit LLMs for recovering the purified samples for given adversarial examples such that they are semantically similar and correctly classified. Applications include software based solutions to increase robustness, reliability, and trustworthiness of text classifiers already deployed.

### CROSS REFERENCE TO RELATED APPLICATIONS

This is a non-provisional patent application that claims benefit to U.S. Provisional Patent Application Ser. No. 63/699,051 filed on Sep. 25, 2024, which is herein incorporated by reference in its entirety.

### GOVERNMENT SUPPORT

This invention was made with government support under W911NF-20-2-0124 awarded by the Army Research Laboratory and under W911NF-21-1-0030 awarded by the Army Research Office. The government has certain rights in the invention.

### FIELD

The present disclosure generally relates to artificial intelligence including large language models (LLMs); and in particular to examples for adversarial text purification.

### BACKGROUND

Despite the tremendous success of text classification models, studies have exposed their susceptibility to adversarial examples, i.e., carefully crafted sentences with human-unrecognizable changes to the inputs that are misclassified by the classifiers. The dependability and integrity of NLP applications are seriously threatened by the vulnerability of text classification models to these attacks. Thus, developing stronger defenses against adversarial attacks is crucial in improving the classification model's robustness.

It is with these observations in mind, among others, that various aspects of the present disclosure were conceived and developed.

### BRIEF DESCRIPTION OF THE DRAWINGS

FIG. 1 is an illustration of a proposed LLM-guided adversarial text purification framework described herein.

FIG. 2 is simplified diagram of a system for implementing the proposed LLM-guided adversarial text purification framework described herein.

FIG. 3A is an example prompt provide to an LLM to elicit a purified version of text.

FIG. 3B is a variant of the prompt illustrated in FIG. 3A.

FIG. 4 is a process flow of an example method associated with the concepts described herein.

Corresponding reference characters indicate corresponding elements among the view of the drawings. The headings used in the figures do not limit the scope of the claims.

### DETAILED DESCRIPTION

The present disclosure generally relates to inventive concepts including frameworks, systems, and methods for using adversarial purification methods to defend text classifiers (without knowledge of the type of attacks or training of the classifier). Adversarial purification is a desirable defense because it does not require prior knowledge of the type of attack. Proposed methods herein use the capabilities of Large Language Models (LLMs) to purify text without having to explicitly classify noise perturbations.

Purification methods can be used to edit the text and remove adversarial perturbations from the text. The model can then correctly classify the text. The inventive concept described herein has been shown to be remarkably more effective in defending against adversarial attacks. Exemplary features include the following.
Classifiers based on two pre-trained masked language models: BERT and ROBERTa; instruction-tuned LLM follows human-written instructions
Prompt PO to elicit the purified version of the text from the LLM
Variant of prompt P1 removes instruction regarding generating text that would correct misclassified label
Variant of prompt P2 prompts the LLM to generate a paraphrased version of the input text

In the following disclosure, the effectiveness of adversarial purification methods in defending text classifiers is investigated. A novel adversarial text purification concept is proposed that harnesses the generative capabilities of Large Language Models (LLMs) to purify adversarial text without the need to explicitly characterize the discrete noise perturbations. Prompt engineering is implemented to exploit LLMs for recovering the purified samples for given adversarial examples such that they are semantically similar and correctly classified. Proposed methods demonstrate remarkable performance over various classifiers, improving accuracy under the attack by over 65% on average.

### 1 INTRODUCTION

Adversarial purification is a type of defense mechanism against adversarial attacks. It characterizes and removes the adversarial perturbations from the attacked inputs to generate purified samples that are similar to the attacked ones and are classified correctly by the classifier. These methods have demonstrated efficacy in the field of image classification without making assumptions on the form of an attack and a classification model, thus being able to defend pre-existing classifiers against unseen threats. The potential of adversarial purification, however, has not been explored for text classification, due to the challenges of characterizing the adversarial perturbations for discrete data. In particular, contrary to images, where perturbations can be generated based on continuous gradients, for text data, adversarial perturbations are generated by manipulating combinations of words in the input text. Therefore, identifying these perturbations is also a combinatorial problem.

An ideal solution to adversarial purification for text is to generate the purified example without explicitly characterizing the noise perturbations. In an attempt to achieve this, Li et al. proposed a greedy approach that randomly masks the adversarial examples and uses their reconstructed versions by the Masked Language Models (e.g., BERT) as benign purified examples. However, due to its greedy nature, this defense can be ineffective for defending text classifiers.

The exponential growth of the sheer size of LLMs has expedited their generative applications in various fields. To study the effectiveness of adversarial purification for texts, it was investigated as to whether LLMs can be exploited to directly generate the purified examples from their adversarial counterparts, eliminating the need for the characterization of adversarial perturbation. To this end, the generative power of instruction-based LLMs was utilized, particularly GPT-3.5, and a prompt was designed to exploit the contextual understanding and capacity of LLMs to recover purified samples.

Compared to the greedy approach of selecting random combinations of tokens iteratively to remove adversarial perturbations, the proposed method exploits the comprehension and contextual understanding of LLMs to effectively reverse the adversarial perturbations, while utilizing their extensive generation power and capacity to produce cohesive, fluent texts. The method demonstrates the effective use of adversarial purification methods for text classification, improving the performance of the classifier under attack by over 65%, and improving the performance of the existing text purification defense by over 25% in most cases. The results open a new avenue for future research in textual adversarial defense based on purification. Example contributions can be summarized as follows:
Studies were conducted to effectively implement the adversarial text purification defense for text.
It is believed that the present disclosure constitutes the innovation to utilize the contextual understanding and capacity of LLMs for effective text-based adversarial purification defense.
Extensive experiments were conducted on two state-of-the-art transformer-based text classifiers which demonstrated the effectiveness of the proposed adversarial purification method in defending the pre-trained classifiers against strong attacks without any knowledge of the attack.

### 2 SUPPORTING CONCEPTS

Adversarial Attacks on Text Classifiers: Over the years there have been various types of adversarial attacks for text, with varying degrees of success on different types of model architectures. Adversarial attacks, broadly categorized into black box and white box, manipulate textual data through insertion, deletion, or swapping of characters and words. The substitution-based strategies to craft adversarial examples employ techniques like genetic algorithms, greedy-search, or gradient-based methods for word replacement. Recent works involving word-level perturbations include TextFooler, BERT-Attack, and TextHoaxer. Alongside the vast body of work on word-level attacks, there is also significant amount of works in character-level and sentence-level attacks.

Adversarial Purification and Other Defenses: Influenced by the rapid development of various adversarial attacks in text, there has also been an increasing number of defense mechanisms to ensure robustness of models against different types of attacks. Some of these defense methods introduce certified robust models to create a defensive range within which substitutions cannot perturb the model. Gradient-based adversarial training strategies have shown effectiveness in defending attacks with no prior knowledge and improving defense. Adversarial purification is a particularly desirable type of defense since it does not require prior knowledge of the type of attack. Prior work in adversarial purification has traditionally focused on continuous inputs such as images, exploring generative models such as GANs, EBMs, and diffusion models. However, the field of creating better adversarial defenses and improving robustness in NLP has experienced considerable interest in recent years. Adversarial purification has been explored; however, it is comparably uncommon in NLP. Some work aims to utilize the contextual and masking capabilities of pre-trained masked language models (such as BERT) in order to create a defense against adversarial attacks. However, here, one aim is to use the power of generative AI. In particular, recent state-of-the-art Large Language Models (LLMs) can be leveraged to perform adversarial purification thereby exploring the possibility of improving the robustness of these models.

LLMs as Pseudo-oracles: Alongside the impressive performance of LLMs on a variety of natural language tasks, LLMs are also being increasingly used as pseudo-oracles, such as in data annotation, as detectors, for model explainability and as experts in general. Inspired by such works, this disclosure proposes to use LLMs to perform adversarial purification in the challenging text domain.

### 3 BACKGROUND

### 3.1 Large Language Models

Large language models (LLMs) are essentially deep networks that are based on transformer networks. Transformer-based LLMs are highly effective models that are capable of learning and generating natural language. Broadly there are two categories of language models: (i) Autoregressive language models and (ii) Masked language models. Autoregressive language models are simply trained to predict the next token in a sentence, thereby learning how to generate fluent text when pre-trained on a large corpora of data. Such models include GPT-2, GPT-3, etc. Masked language models (MLMs) are bi-directional models that learn by first masking some fraction of tokens in the sentence and then predicting appropriate tokens to fill the masked slots. Examples of such models include BERT, ROBERTa, etc. The bidirectional nature of MLMs help the models to have higher language understanding capabilities, and thereby better performance on NLU tasks. More recently, autoregressive models such as the GPT-3 family of models are also being further trained via instruction-tuning with (instruction, response) text pairs, whereby the model learns to generate text to follow user-specified instructions and perform tasks. Some of these instruction-tuned models undergo further training steps (e.g., via RLHF) to align their responses with human preferences. State-of-the-art LLMs such as GPT-3.5 and GPT-4, and GPT-5 from OpenAI demonstrate impressive performance when it comes to understanding long and complex human-written instructions in the prompts, as well as editing and generating text.

### 3.2 Adversarial Text Purification

Adversarial purification is an adversarial defense mechanism that is relatively newer in the natural language domain. As elaborated in the previous section, this method has been well explored in the domain of computer vision, whereby generative models are used to perform the purification. In the image domain, the standard method is to inject random noise into a perturbed input image, and then use a generative model i.e., the purification algorithm to reconstruct the original clean image from the noisy image over multiple rounds. The generated image would now be free of the adversarial perturbations. However, in the domain of text, the discrete nature of the input makes it infeasible to apply the standard computer vision methods directly. One recent attempt at adversarial text purification uses masked language models to randomly mask multiple copies of the perturbed text, and then recovering the text by filling in the mask using the masked language model. This method essentially is somewhat similar to the standard process of injecting noise and iteratively reconstructing the input, as followed in the image domain. However, there is no other method for performing adversarial text purification. To fill this gap, the inventive concept described herein directly leverages the instruction understanding and text generation capabilities of recent state-of-the-art LLMs to perform LLM-guided text purification.

### 4 LLM-GUIDED ADVERSARIAL TEXT PURIFICATION

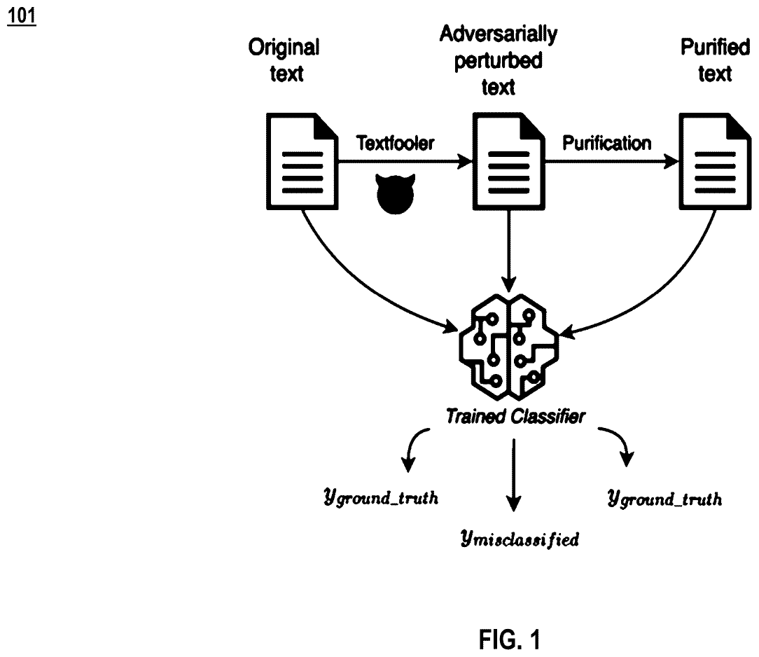

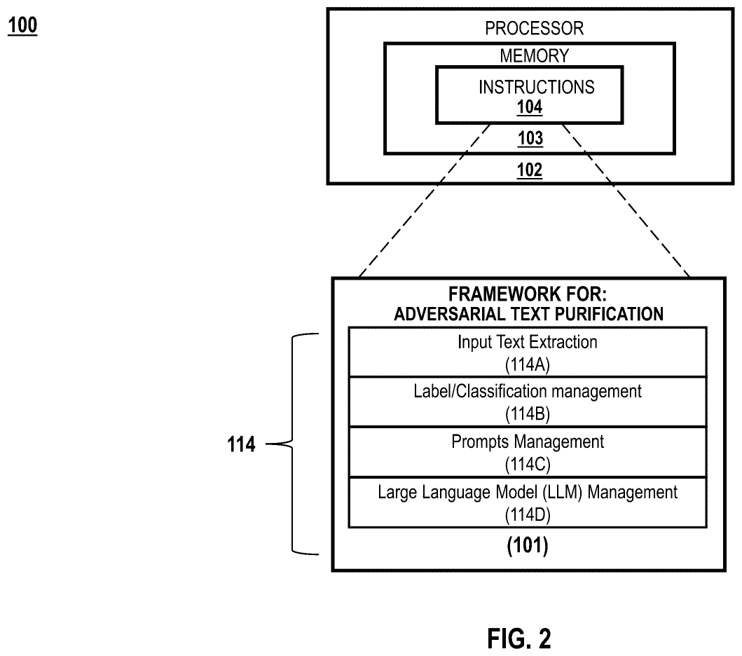

In this section, an inventive technical solution including a purification framework is presented and example design choices are explained. The purification framework, designated framework 101, is shown in FIG. 1, and FIG. 2 shows an example of a system 100 for LLM-guided adversarial text purification via the framework 101. In the non-limiting example shown, the system 100 includes at least one processor 102, and at least one of a memory 103 or storage device storing instructions 104 accessible by the processor 102. In general, the processor 102 is configured, via the instructions 104, to implement the framework 101 via a network or otherwise. As an example, the framework 101 can include components 114 that support functionality and operations disclosed herein.

In some examples, the framework 101 includes prompts, logic, and other instructions to guide an LLM to elicit a purified version of input text. As indicated in FIG. 2, the framework 101 be implemented as computer-implemented instructions (104) for LLM-guided adversarial text purification, and can be implemented at an edge device, via cloud-based deployment, etc. Components 114 or services of the framework 101 can include by non-limiting examples input text extraction 114A, label and classification management 114B, prompts management 114C, and large language model (LLM) management 114D. The aforementioned instructions 104 can be implemented as code and/or machine-executable instructions executable by the processor 102 that may represent one or more of a procedure, a function, a subprogram, a program, a routine, a subroutine, a module, service, an object, a software package, a class, or any combination of instructions, data structures, or program statements, and the like. In other words, the instructions 104 or any operations performed by the processor 102 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103), and the processor 102 performs the tasks defined by the code.

Regarding further detail of the framework 101, one focus is on the task of text classification and fine-tuned pre-trained language models (such as BERT), denoted by f(⋅) can be used as the classifier. During inference, such a classifier is evaluated on the test set of a task dataset (Xₜₑₛₜ, Yₜₑₛₜ) where Xₜₑₛₜ and Yₜₑₛₜ are the sequence of input texts and associated ground truth labels, respectively. For an input text xᵢ∈Xₜₑₛₜ, say the classifier correctly predicted f(xᵢ)=yᵢ, or yy_{ground_truth} for ease of reference. Now, say this text is perturbed by an adversarial attack method such that the perturbed text xᵢ′ now gets misclassified to a different label, say y_{misclassified}. While many defense mechanisms train the model, i.e., the classifier, to be adversarially robust to some specific categories of perturbations, purification methods enable simply editing the text, ideally removing the adversarial perturbation from the text and thereby enabling the model to correctly classify the text. Following this, a set of adversarially perturbed input texts Xₜₑₛₜ′ were collected and attempts were made to purify them by using off-the-shelf large language models.

In order to purify the set of adversarially perturbed input texts Xₜₑₛₜ′, prompts were carefully designed and implemented, as elaborated in the following paragraph. After the purification step, the \tilde{X}ₜₑₛₜ can be obtained which is then correctly classified by the classifier in majority of the cases.

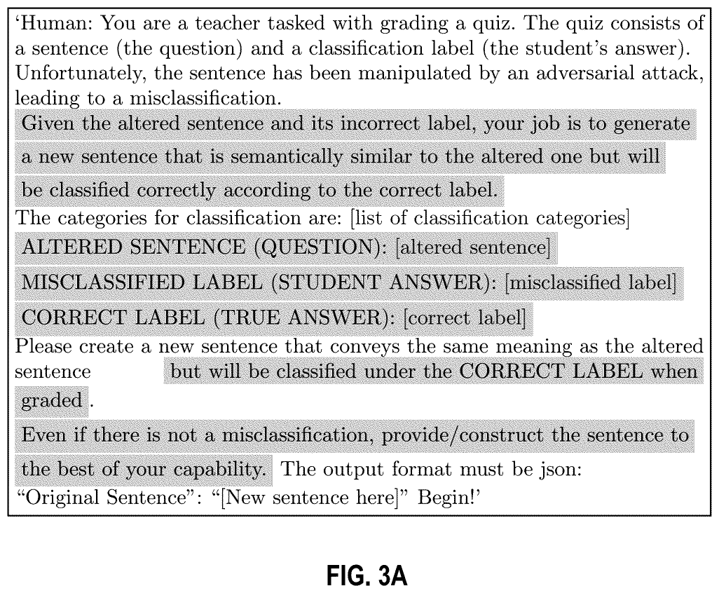

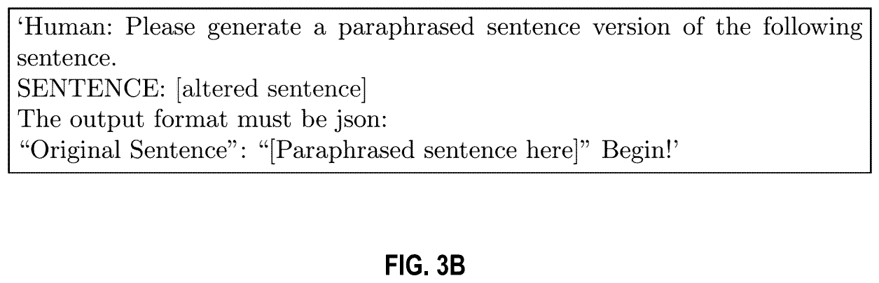

An instruction-tuned LLM can be implemented which is capable of following human-written instructions in the prompt, in order to generate the purified samples. To enable this, one example of a carefully designed prompt is illustrated in FIG. 3A. In the prompt shown in FIG. 3A, [altered sentence] refers to the adversarially perturbed input text xᵢ′, [misclassified label] refers to y_{misclassified}. [correct label] refers to y_{ground_truth} and [list of classification categories] refer to the list of possible labels for the particular classification task. As evident in the prompt, we ‘prime’ the LLM to enable it to act like a knowledgeable teacher, thereby guiding the editing process. Illustrated is the prompt used for eliciting the purified version of the text from the LLM, and this prompt can be denoted as P0.

To investigate the efficacy of this carefully designed prompt, further design and variations were generated including two variants of this prompt: P1: which removes the instruction regarding generating text that would correct the misclassified label, and P2: which essentially prompts the LLM to generate a paraphrased version of the input text. The prompt P1 is created by simply removing the shaded text from P0. The prompt P2 is shown in FIG. 3B.

### 5 EXPERIMENTS

Extensive experiments were conducted to evaluate the effectiveness of the proposed LLM-guided adversarial purification method. The experiments were designed to examine the three main aspects of the method: (i) effectiveness of the proposed method; (ii) ablation study of the components of the designed prompt; and, (iii) case study of the purified examples. In the following, the experimental setting is first explained followed by experimental results.

### 5. 1 Experimental Setting

In this section, datasets, the adversarial attack, and the LLM used in the experiments are described. Further described are the relevant defense baselines used to compare the method to and information is provided on the experimental setup to ensure reproducibility. Note that the experimental settings closely follow the ones in the state-of-the-art methods.

Datasets. Experiments were conducted on two commonly-used benchmark NLP datasets: (1) IMDb: for sentiment classification of movie reviews where each review is labeled with a positive or negative label, and (2) AG News: news topic classification where each article is labeled with one of the four categories of {science, business, world, sports}.

Adversarial Attack and Defense Baselines. For all experiments one of the strongest textual attacks was used, named TextFooler. Similar to the baselines, the open-source implementation of TextAttack library was implemented. The TextFooler attack is selected due to its efficient generation of strong and highly successful adversarial examples, making it an ideal attack to assess the effectiveness of the defense mechanisms. Following previous work, for the size of candidate list K={12,50} was chosen in the experiments.

The performance of the method was compared with two types of adversarial defense, namely (1) Textual adversarial training methods: these methods are based on adversarial training of the classifiers using the adversarial examples generated based on the gradients of the latent space. Adv-HotFlip and FreeLB were used, two state-of-the-arts in this category. For the choice of baseline defenses, as well as the FreeLB++, which requires the candidate list; and (2) Textual adversarial purification methods: methods based on purifying the adversarial examples to generate correctly-classified benign examples. It is believed that only one text adversarial purification method exists. This method was included as the baseline.

Classifier. Classifiers were used based on two pre-trained masked language models: BERT and ROBERTa. For each dataset, BERT and ROBERTa models were used from Huggingface Transformers (bert-base-uncased (https://huggingface.co/bert-base-uncased) and roberta-base (https://huggingface.co/roberta-base)), fine-tuned on that specific dataset. Note that the proposed method does not require any further fine-tuning or adversarial training of the model and one can simple query the fine-tuned BERT and ROBERTa models in an off-the-shelf manner. For evaluating the framework, reporting included the post-attack accuracy, with and without the purification method, along with the original classifier accuracy without any attack.

TABLE 1
Comparison of the LLM-guided purification methods with
baselines as described in Sect. 5.1. Bold denotes the
best performance in terms of recovered accuracy, and
underline implies the second-best performance.

| | Original | TextFooler | TextFooler |
|---|---|---|---|
| Defense ↓ | Accuracy | (K = 12) | (K = 50) |
| IMDb ↓ | | | |
| fine-tuned BERT | 94.1 | 20.4 | 2.8 |
| Adv-HotFlip (BERT) | 95.1 | 36.1 | 8.0 |
| FreeLB (BERT) | 96.0 | 30.2 | 7.3 |
| FreeLB++ (BERT) | 93.2 | — | 45.3 |
| Text purification (BERT) [18] | 93.0 | 81.5 | 51.0 |
| Text purification (RoBERTa) | 96.1 | 84.2 | 54.3 |
| [18] | | | |
| (Ours) LLM-guided purification | 94.54 | 79.34 | 73.52 |
| (BERT) | | | |
| (Ours) LLM-guided purification | 95.06 | 78.9 | 76.16 |
| (RoBERTa) | | | |
| AG News ↓ | | | |
| fine-tuned BERT | 92.0 | 32.8 | 19.4 |
| Adv-HotFlip (BERT) | 91.2 | 35.3 | 18.2 |
| FreeLB (BERT) | 90.5 | 40.1 | 20.1 |
| Text purification (BERT) [18] | 90.6 | 61.5 | 34.9 |
| Text purification (RoBERTa) | 90.8 | 59.1 | 34.2 |
| [18] | | | |
| (Ours) LLM-guided purification | 95.12 | 83.58 | 81.3 |
| (BERT) | | | |
| (Ours) LLM-guided purification | 94.76 | 82.84 | 81.4 |
| (RoBERTa) | | | |

Implementation Details. OpenAI's GPT-3.5 (version as of November 2023) was used along with the inventive carefully designed prompts to obtain purified versions of adversarially altered texts. The process involved crafting prompts that guide the model to generate semantically similar but unperturbed versions of the input texts. GPT-3.5 was chosen for its advanced contextual understanding and generative capabilities. The process was automated and experiments were implemented in Pytorch run on two systems: (1) Linux system with one A30 and (ii) Linux system with four A100s.

### Effectiveness of Proposed Purification Method

### 5.2 Results and Discussion

In this section, one aim is to answer if the LLM-based adversarial text purification method described herein is able to effectively purify the adversarial examples. For the sake of comparison, the accuracy under attack for vanilla fine-tuned classifiers is reported. The defense is applied and the state-of-the-art adversarial defenses on the IMDB and AG News datasets and the results are reported in Table 1. The results demonstrate that the proposed method effectively defends the state-of-the-art transform-based text classifiers, improving their accuracy under attack by more than 60% in most cases.

Elaborations include the following: (1) the adversarial training-based defenses, i.e., Adv-HotFlip, FreeLB, and FreeLB++, are constantly outperformed by the instant method based on purification by a large margin (more than 30%). This is because these models are robustified against continuous gradient-based adversarial perturbations and not the discrete word-level perturbations used by text adversarial attacks; (2) the state-of-the-art purification-based defense, namely Text purification, has remarkably lower performance compared to the inventive method described herein. This is because the Text purification method is based on a greedy approach and iteratively selects and perturbs random words. The method herein, on the other hand, utilizes the power of LLMs to directly generate purified examples; and (3) finally, the method (LLM-guided purification) achieves the highest after attack accuracy, which is comparable to the accuracy of the model before the attack. For instance, for the BERT trained on the AG News dataset, the original accuracy before the attack is 95.06%, whereas the accuracy after the attack is 83.58%, which is more that 20% better than the accuracy under attack for the second best-performing defense (Text purification (BERT)).

TABLE 2
Effectiveness of the full prompt as
described in Sect. 4 (denoted by P0).

| Prompt Type | AG News |
|---|---|
| Original (BERT) | 95.12 |
| Full prompt P0 | 81.3 |
| P1 | 78 |
| P2 | 52.7 |

Ablation: Effectiveness of Prompt Components. In this section, experiments were conducted with two additional prompts namely P1 and P2 as explained in section 4, and their results were compared with the results obtained using the main prompt (P0). Specifically, P1 is designed to understand the effect of the explicit instruction to ensure the purified text is classified as the correct label. The goal of designing P2 is to assess the effectiveness of the proposed prompt to ensure the purified samples retain semantic similarity to the adversarial counterparts. To this end P2 simply asks the LLM to paraphrase the adversarial example.

TABLE 3
Examples from the AG News dataset with TextFooler perturbations (with both K = 12 and K = 50) along with LLM-
purified versions of the perturbed input. Portions of the input text altered by the TextFoolor method are shown underline.
Labels in bold are correctly classified, while labels in italics are misclassified. It can be observed that the methods
described herein successfully retain the original label after attack, while maintaining semantics of the original input.

| | Texts | Label |
|---|---|---|
| Original | E-mail scam targets police chief Wiltshire Polic | science |
| | warns about “phishing” after it's fraud squad | |
| | chief was targeted | |
| Adv. | E-mail scam targets gendarmeric chief Wiltshire | the |
| Perturbed | Polic warns about “phishing” after its deception | world |
| (K = 12) | battalion massa was targeted | |
| LLM- | Wiltshire Police issues warning about phishing | science |
| purified | email scam targeting their deception battalion | (conf.: |
| | massa. | 0.0994) |
| Adv. | E-mail scam targets police chief Wiltshire Polic | the |
| Perturbed | warns about “phishing” after the hoax battalion | world |
| (K = 50) | leiter was targeted. | |
| LLM- | Wiltshire Police alerts about a scam email | science |
| purified | targeting their police chief, warning about phishing | (conf.: |
| | after their hox battalion leiter was targeted. | 0.984) |
| Original | Consumer Prices Down, Industry Output Up | business |
| | WASHINGTON (Reuters) - U.S. consumer prices | |
| | dropped in July for the first time in eight months as | |
| | a sharp run up in energy costs reversed, the | |
| | government said in a report that suggested a slow | |
| | rate of interest rate hikes is likely. | |
| Adv. | Eaters Pricing Down, Departments Product Arriba | science |
| Perturbed | WASHINGTON (Reuters) - U.S. consuming | |
| (K = 12) | prices declined in July for the first time in eight | |
| | months as a ferocious manage up in energy costs | |
| | quashed, the government tell in a notification that | |
| | recommendations a sluggish cadence of | |
| | relevance pace hiking is possible. | business |
| LLM- | Consumers face lower prices as government | (conf.: |
| purified | report suggests slower pace of interest rate hikes | 0.954) |
| | due to decrease in energy costs. | |
| Adv. | User Charging Down, Industry Product Up | science |
| Perturbed | WASHINGTON (Reuters) - U.S. clients prices | |
| (K = 50) | dwindled in July for the first time in eight months | |
| | as a sharp run up in energy costs quashed, the | |
| | government tell in a report that recommendation a | |
| | slow rate of interest rate hikes is likely. | |
| LLM- | U.S. consumer prices fell in July for the first time | business |
| purified | in eight months due to a significant increase in | (conf.: |
| | energy costs, as reported by the government. This | 0.999) |
| | suggests that a pace of interest rate hikes is likely | |
| | to slow down. | |

The results reported in Table 2 indicate the effectiveness of the main prompt P0. The accuracy under attack for purification based on P1 is about 4% less than the full prompt P0. This indicates that even though the full prompt is useful to achieve higher performance, the proposed methodology can obtain similar performance, even when the original correct label of the sample is unknown. However, the performance achieved with P2 is remarkably lower compared to the main prompt, indicating that the proposed prompt is indeed necessary for a successful adversarial purification.

Case Study. Some examples from the AG News dataset are showcased in Table 3. One can observe that the purified examples are semantically similar to the adversarial examples while being classified to the original correct class before the attack. This shows that the method can successfully remove the adversarial perturbation and does not change the original benign content of the example. It is important to note that the method can effectively remove adversarial perturbations of any length with only one prompt. Additionally, the generated examples are fluent and grammatically correct, due to the generative power of the LLMs.

### 6 NON-LIMITING CONCLUSIONS

In this disclosure, a novel text adversarial purification method is described that can effectively remove the adversarial perturbations of any lengths from the adversarial examples and generate purified examples that are semantically similar but are classified to the original correct class. Overcoming the challenges of characterizing adversarial perturbations for discrete inputs (i.e., text), the method utilizes the advanced contextual understanding and generative capabilities of the LLMs to effectively purify the adversarial examples. The method results in an average accuracy improvement of over 65% under attack.

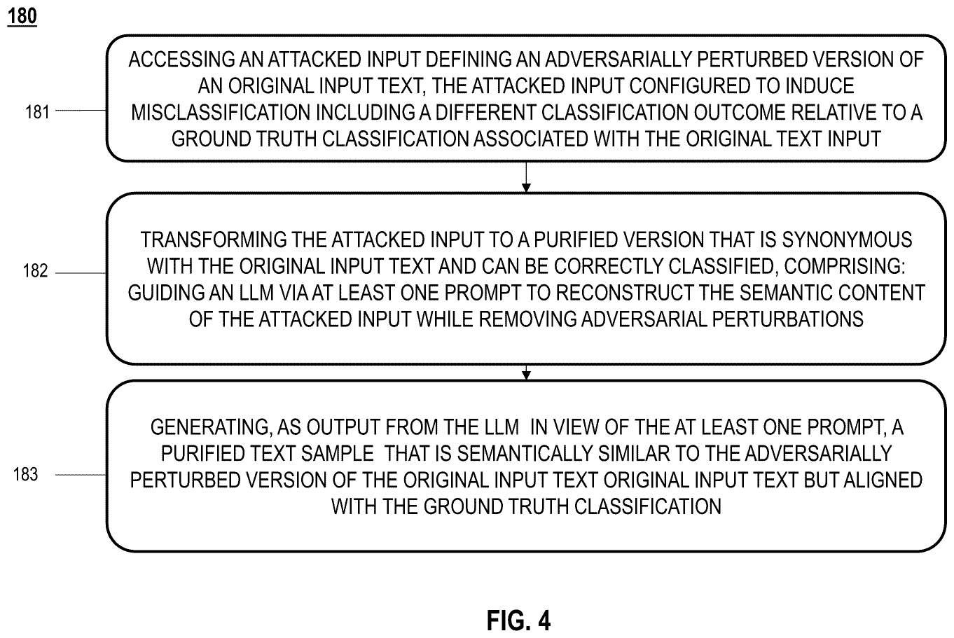

FIG. 4 is a non-limiting example method 180 associated with the inventive concepts described herein including steps 181-183.

The foregoing description has been directed to specific embodiments. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method of defending against adversarial attacks by adversarial text purification, comprising:
accessing an attacked input defining an adversarially perturbed version of an original input text, the attacked input configured to induce misclassification including a different classification outcome relative to a ground truth classification associated with the original text input; and
transforming the attacked input to a purified version that is synonymous with the original input text and can be correctly classified, comprising:
guiding an LLM via at least one prompt to reconstruct the semantic content of the attacked input while removing adversarial perturbations, and
generating, as output from the LLM in view of the at least one prompt, a purified text sample that is semantically similar to the adversarially perturbed version of the original input text original input text but aligned with the ground truth classification.

2. The method of claim 1, further comprising:
classifying, by a trained classifier, the purified text sample to produce a classification output corresponding to the ground truth classification associated with the original input text.

3. The method of claim 1, wherein the purified text sample is generated without explicitly characterizing adversarial perturbations associated with the attacked input.

4. The method of claim 1, wherein the at least one prompt is configured to understand an effect of an explicit instruction to ensure the purified text sample is classified as the ground truth classification.

5. The method of claim 1, wherein the at least one prompt elicits the LLM to generate a paraphrased version of the attacked input.

6. The method of claim 1, wherein the LLM comprises a generative transformer-based model selected from the group consisting of GPT-3, GPT-3.5, GPT-4, GPT-5, or a fine-tuned variant thereof.

7. The method of claim 1, wherein the at least one prompt is configured to ensure the purified text sample retains semantic similarity to the attacked input.

8. The method of claim 1, wherein the at least one prompt is configured to elicit the LLM to generate the purified text sample to be benign such that it avoids misclassification but maintains semantically similarity relative to the original input text.

9. The method of claim 1, wherein the at least one prompt harnesses the generative capabilities of the LLM to purify adversarial text without the need to explicitly characterize the discrete noise perturbations.

10. The method of claim 1, wherein transforming the attacked input into the purified text sample improves classification accuracy of a classifier under adversarial attack relative to classification of adversarially perturbed input texts without purification.

11. A system for defending a text classifier against adversarial attacks, the system comprising:
one or more processors; and
a memory storing instructions that, when executed by the one or more processors, cause the one or more processors to:
receive an input text comprising an adversarially perturbed version of an original text,
generate a purified text sample that is semantically similar to the original text but free of adversarial perturbations by engagement of an LLM via prompt engineering, and
classify the purified text sample using the text classifier to produce a classification output corresponding to an intended classification for the original text.

12. The system of claim 11, wherein the prompt engineering is configured to elicit a paraphrased version of the adversarially perturbed input text from the LLM.

13. The system of claim 11, wherein generating the purified text sample improves classification accuracy of the text classifier under adversarial attack by at least 25 percent relative to classification of adversarially perturbed input texts without purification.

14. The system of claim 11, wherein the prompt engineering harnesses the generative capabilities of the LLM to purify adversarial text without the need to explicitly characterize the discrete noise perturbations.

15. The system of claim 11, wherein the LLM comprises a generative transformer-based model selected from the group consisting of GPT-3, GPT-3.5, GPT-4, GPT-5, or a fine-tuned variant thereof.

16. The system of claim 11, wherein the purified text sample is generated without explicitly characterizing adversarial perturbations associated with an attacked input.

17. The system of claim 11, wherein the prompt engineering includes a plurality of prompts that guide the LLM to ensure the purified text sample retains semantic similarity to its adversarial counterparts.

18. The system of claim 11, wherein the one or more processors implement automated text purification using two Linux systems implemented in Pytorch.

19. The system of claim 11, wherein the prompt engineering includes reference to parameters including an altered sentence associated with adversarially perturbed input text, a misclassified label, a correct label, and a list of classification categories referring to possible labels for the input text, and the LLM is guided to generate the purified text sample via reference to the parameters.

20. The system of claim 11, wherein the text classifier comprises a masked language model selected from the group consisting of BERT and ROBERTa.
